(19) United States
(12) Patent Application Publication
(10) Pub. No.: US 2016/0059276 A1
(43) Pub. Date: Mar. 3, 2016

(54) DEDUSTING AND DESTATICIZING DEVICE

(71) Applicants: BOE TECHNOLOGY GROUP CO., LTD., BEIJING (CN); BOE OPTICAL SCIENCE AND TECHNOLOGY CO., LTD., SUZHOU (CN)

(72) Inventor: David YAN, Beijing (CN)

(21) Appl. No.: 14/551,585

(22) Filed: Nov. 24, 2014

(30) Foreign Application Priority Data
Aug. 29, 2014 (CN) 201410436252.9

(51) Int. Cl. B08B 6/00; B08B 5/02

(52) U.S. Cl. CPC B08B 6/00; B08B 5/02

(57) ABSTRACT

A dedusting and destaticizing device is disclosed and the dedusting and destaticizing device comprises an electrostatic eliminator, a worktable and a gas curtain generating element; the electrostatic eliminator comprises an ionic wind nozzle and is configured for spraying an ionic wind toward the worktable so as to remove static electricity and dust from an object to be cleaned on the worktable; the worktable is provided below the ionic wind nozzle of the electrostatic eliminator and configured for placement of the object to be cleaned and discharge of the dust; and the gas curtain generating element is provided above the worktable and configured for spraying a gas toward the worktable, so as to form a gas curtain around the object to be cleaned. The dedusting and destaticizing device can integrate a destaticizing function, a dedusting function, a dust collection function and the like, facilitate operations; and avoid polluting the surrounding environment.

### TECHNICAL FIELD

At least one embodiment of the present disclosure relates to a dedusting and destaticizing device.

### BACKGROUND

TFT-LCD industry is an industry having a high requirement for the cleanliness, and especially in the pipeline for manufacturing a backlight source, various dedusting equipments are arranged due to the very high requirement for dedusting effect.

For example, a backlight film material is subjected to unpacking, cleaning, packaging, distributing and similar procedures, so as to ensure the cleaning of the material as far as possible.

### SUMMARY

At least one embodiment of the present disclosure provides a dedusting and destaticizing device to remove the static electricity and dust on a component without polluting the surrounding environment.

At least one embodiment of the present disclosure proposes a dedusting and destaticizing device, which includes an electrostatic eliminator, a worktable and a gas curtain generating element; the electrostatic eliminator includes an ionic wind nozzle and is configured for spraying an ionic wind toward the worktable so as to remove static electricity and dust from an object to be cleaned on the worktable; the worktable is provided below the ionic wind nozzle of the electrostatic eliminator and configured for placement of the object to be cleaned and discharge of the dust; and the gas curtain generating element is provided above the worktable and configured for spraying gas toward the worktable, so as to form a gas curtain around the object to be cleaned.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a side view of a dedusting and destaticizing device according to one embodiment of the present disclosure;

FIG. 2 is a top view of a dedusting and destaticizing device according to one embodiment of the present disclosure;

FIG. 3 is a rear view of a dedusting and destaticizing device according to one embodiment of the present disclosure;

FIG. 4 is a front view of a dedusting and destaticizing device according to one embodiment of the present disclosure; and

FIG. 5 is a structural block diagram of a control element and connection relationship thereof of a dedusting and destaticizing device according to one embodiment of the present disclosure.

### REFERENCE NUMERALS

1—conduit; 1a—ionic wind nozzle; 101—ionic blower; 2—worktable; 3—gas curtain generating element; 31—gas-jetting nozzle; 4—lateral cover; 41—opening; 5—top cover; 51—hole; 6—air extractor; 61—dust exhaust hole; 7—sensing element; 9—time regulating element; 11—rear box; 12—support sidewall; 13—air inlet element; 14—filter element; 15—air gauge; 16—gas-pressure regulating element; 17—power switch; 18—power supply interface.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

The inventor of the present application noticed that, for example, with the increase of the times of turnover and waiting time of the procedures of a backlight film material etc., the material have a gradually increased possibility of being subjected to contamination. Furthermore, when cleaning a TFT-LCD component, it's possible to prevent the cleaned component from being stained after the completion of a light guide plate manufacture till before the lamination process, that is, the dust contamination during turnover processes may be avoided, however, the dust can still continuously deteriorate surrounding environment and cause contamination to other components.

As shown in FIG. 1, a dedusting and destaticizing device according to one embodiment includes an electrostatic eliminator, a worktable 2 and a gas curtain generating element 3; the electrostatic eliminator includes an ionic wind nozzle 1a and is configured for spraying an ionic wind toward the worktable 2 so as to remove static electricity and dust from an object to be cleaned on the worktable 2; the worktable 2 is provided below the ionic wind nozzle 1a of the electrostatic eliminator for the placement of the object to be cleaned and the discharge of the dust; and the gas curtain generating element 3 is provided above the worktable 2 and configured for spraying a gas toward the worktable 2, so as to form a gas curtain around the object to be cleaned.

The ionic wind sprayed by the electrostatic eliminator may, on one hand, blow off the dust on the object to be cleaned, and on the other hand, ions in the ionic wind may neutralize with the static electricity on the object to be cleaned, and thus the dust and static electricity on the object to be cleaned are removed. It's to understandable that, after the gas curtain generating element 3 sprays gas toward the worktable 2, the gas curtain generated around the worktable can form a cavity together with the worktable 2, and the object to be cleaned placed on the worktable is located within the cavity. When the electrostatic eliminator sprays an ionic wind toward the worktable 2, it can be guaranteed that, on one hand, the dust blown off by the ionic wind is unlikely to fly off the worktable 2 and then is completely discharged by the worktable 2, and on the other hand, a driving force can be supplied to the dust in a direction identical to that of the ionic wind sprayed toward the worktable 2, so that the dust passes the worktable 2 and is discharged, thus avoiding polluting other objects to be cleaned around the worktable, and improving the overall dedusting effect for elements on the pipeline.

For example, the gas curtain generating element 3 may be provided above an edge of the worktable 2 to generate a gas curtain at the edge of the worktable 2, so part of the dust falling off the object to be cleaned has to travel a certain distance before contacting the gas curtain, and is not likely to pass through the gas curtain and then to fly off the worktable 2 due to too fast speed. The gas curtain generated by the gas curtain generating element 3 may be formed of air, and may also be formed by spaying other gas (for example, an inert gas) according to the need. The following embodiments of the present disclosure are illustrated with the example of spraying air.

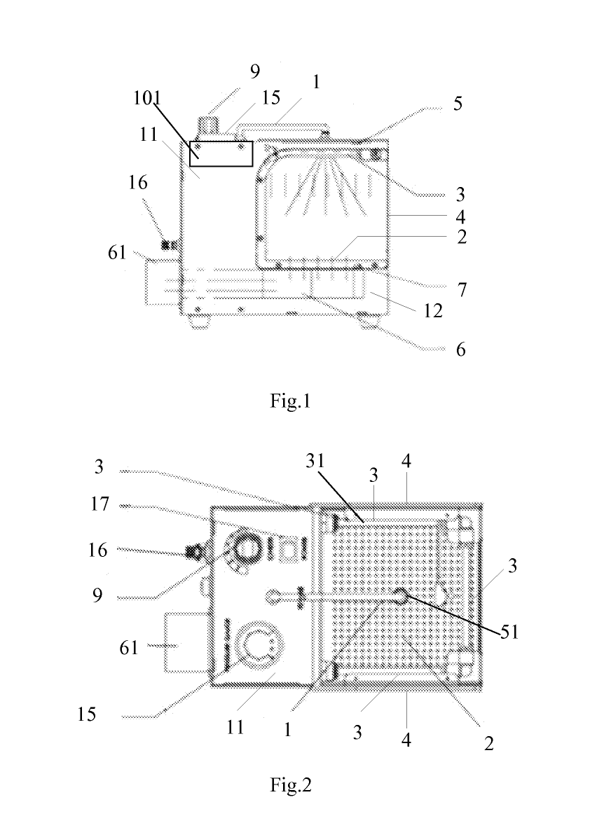

As shown in FIG. 2, in one embodiment of the present disclosure, the gas curtain generating element 3 may include a first, second, third strip gas-jetting nozzles 31, each of the first and second strip gas jetting nozzles is provided with an end coupled with the rear box 11 on a side of the worktable 2 and with another end coupled with the third gas jetting nozzle 31. It's understandable that the provision of the rear box 11 may omit the generation of the gas curtain at a side so as to save the cost. The rear box 11 is coupled with an air inlet element 13, for example, the rear box 11 is provided therein with a gas directing pipe coupled with the air inlet element 13, in such a way that the rear box 11 supplies air to the gas curtain generating element 3 on one hand, and supplies air to the electrostatic eliminator on the other hand. If the gas curtain is formed of other gas, additional gas directing pipe and air inlet may be added so as to supply other type of gas to the gas curtain generating element 3.

In one embodiment, the dedusting and destaticizing device may further include a support sidewall 12 provided below the worktable 2 along an edge of the worktable 2 and configured for supporting the worktable 2.

In at least one embodiment, the rear box 11 may be connected to the support sidewall 12 and be provided on a side of the worktable 2 along an edge of the worktable 2; and the electrostatic eliminator may further include an ionic blower 101 and a conduit 1. The ionic blower 101 is provided within the rear box 11 (not shown in the drawings) and configured for generating ions, mixing the ions with air and blowing the ions and the air into the conduit 1 so as to form the ionic wind; and an end of the conduit 1 is coupled to an upper surface of the ionic blower, and the other end continues to the upper side of the worktable 2 to form the ionic wind nozzle 1a, and the conduit 1 is configured for directing the ionic wind to the upper side of the worktable 2, such that the ionic wind moves toward the worktable 2 from top to bottom. The ionic blower may be a destaticizing equipment for static elimination by ionizing the air to generate an ionic wind, and is generally constituted by a corona discharge device, a high voltage supply and an air supply system. The ionic blower can eliminate static electricity on an insulating material and other object. The ionic wind is directed by the conduit 1, which, on one hand, can ensure that the ionic wind moves toward the worktable 2 from top to bottom so that the ionic wind can provide part of the driving force to drive the dust to be discharged from the worktable, and on the other hand, can restrict the ionic wind produced by the ionic blower 11 to be emitted from a minor room, so as to increase the pressure of the emitted ionic wind, and thus to improve the dedusting and destaticizing effect.

As shown in FIG. 2, in one embodiment of the present disclosure, the fan in the ionic blower can blow the ionic wind upward into the conduit 1, and the conduit 1 may be led out from the upper surface of the rear box 11 and then cross the top cover 5 to spray an ionic wind toward the worktable 2. In another embodiment, an air compression device may also be provided at the connecting portion between the conduit 1 and the ionic blower, so as to improve the pressure of the air sprayed out from the conduit 1, and to further improve the dedusting and destaticizing effect. Of course, embodiments of present disclosure are not limited thereto, and the electrostatic eliminator may also be arranged in other manners.

In at least one embodiment, the dedusting and destaticizing device may further include a lateral cover 4 and a top cover 5. The lateral cover 4 is provided outside an edge of the worktable 2, and an opening 41 is provided for the lateral cover 4, so as to make it easier to place the object to be cleaned into the worktable 2 and to take the object to be cleaned out from the worktable 2; and the top cover 5 is provided above the gas curtain generating element 3 and with a through hole 51 provided thereon, and the conduit 1 passes the through hole 51 to spray the ionic wind toward the worktable 2. The provision of the lateral cover 4 and the top cover 5 can further ensure that the dust blown off the object to be cleaned is unlikely to fly off the worktable 2.

In the embodiments illustrated in FIGS. 1 to 4, a side of the worktable 2 is provided with a rear box 11 (an ionic blower 11 and the like may be placed inside the rear box 11), so the lateral cover 4 includes three faces which forms a three-dimensional space together with the top cover 5 and one face of the rear box 11. The gas curtain generating element 3 is provided with three gas-jetting nozzles 3 corresponding to the three faces of the lateral cover 4, so as to spray air (as shown in FIG. 2). One of the three faces of the lateral cover 4 is provided with an opening, which for example, can be provided at the front side of the device, and through the opening, a user can place the object to be cleaned into the worktable 2 or taking out the object to be cleaned from the worktable 2.

Of course, a user may design the shape of the overall device as required. For example, when the ionic blower is placed below the worktable 2, there is no rear box 11 on the side of the worktable 2, and the lateral cover 4 has four faces. Accordingly, herein, the gas curtain generating element 3 includes four gas jetting nozzles for spraying air, so as to ensure that the dust is unlikely to fly out from the surrounding of the worktable.

For example, the lateral cover 4 may be made of a transparent material so as to make it easier for the user to watch the cleanup situation of the object to be cleaned, and the top cover 5 may be made of a metal material presenting higher strength so as to ensure the structural strength of the upper surface of the device.

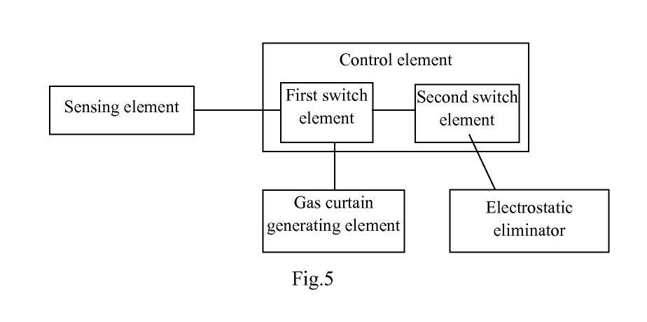

In at least one embodiment, the deducting and destaticizing device may further include a sensing element 7 and a control element. The sensing element 7 is used to sense whether there is the object to be cleaned on the worktable 2; and as shown in FIG. 5, the control element is coupled to the sensing element 7 (to perform on-off control by receiving the electrical signal from the sensing element 7), and is used to successively control the gas curtain generating element 3 and the electrostatic eliminator to be turned on when the sensing element 7 senses an object to be cleaned on the worktable 2. The control element may be a controller with programmable logic device, for example.

In one embodiment, as shown in FIG. 5, the control element may include a first switch element and a second switch element. The first switch element is coupled to the sensing element to control the gas curtain generating element 3 to be turned on when the sensing element senses an object to be cleaned on the worktable; and the second switch element is coupled to the first switch element so as to control the electrostatic eliminator to be turned on when the gas curtain generating element is turned on.

As shown in FIG. 1, the sensing element 7 may employ an element such as a gravity sensor or a photoelectric transducer, and may be provided onto the worktable 2 or onto the top cover 5 as required, or a pair of sensing elements may be provided onto the worktable 2 and the top cover 5. When the sensing element 7 detects that there is an object to be cleaned on the worktable 2, the sensing element 7 signals to the control element so as to automatically turn on the electrostatic eliminator and the gas curtain generating element 3 to perform cleaning, which improves the automaticity of the overall device and makes the integrated operation more convenient.

In at least one embodiment, the dedusting and destaticizing device may further include a time regulating element 9 for setting operation duration of the electrostatic eliminator. Here when the working time period of the control element reaches the operation duration, the gas curtain generating element 3 and the electrostatic eliminator are turned off.

As shown in FIG. 2, the time regulating element 9 may be, for example, a knob provided on the upper surface of the rear box 11 at a side of the worktable 2. The location of the time regulating element 9 may also be varied as required, and the time regulating element 9 may also be a touch screen or a similar device that can be used for setting a time. Through the time regulating element 9 (which may be a timer, for example) and the control element, it's possible to automatically end the cleaning operation after cleaning for a certain duration, so as to further improve the automaticity of the overall device. A power switch 17 may further be provided on the upper surface of the rear box 11, so that the user may turn on or turn off the whole device manually as required.

In at least one embodiment, the power switch 17 may also be configured to be the one dedicated to a certain specific element, for example, a switch for controlling the electrostatic eliminator or a switch for controlling the gas curtain generating element 3. A power supply interface 18 may be provided at the back of the device for the plugging of a power plug.

In at least one embodiment, the dedusting and destaticizing device may further include an air inlet element 13 and a filter element 14. The air inlet element 13 is configured for supplying air to the gas curtain generating element 3 and/or the electrostatic eliminator; and the filter element 14 is provided in the inlet of the air inlet element 13 and configured for filtering the air that enters the air inlet element 13.

For example, the air inlet element 13 may be provided at the back of the device and be connected to the gas curtain generating element 3 and the electrostatic eliminator, and through the filter element 14, it's possible to ensure the cleanliness of the air entering the air inlet element 13, so that the airflow sprayed from the gas curtain generating element 3 and the electrostatic eliminator causes no contamination to the object to be cleaned.

For example, the air inlet element 13 may be a single air inlet, and may also adopt an air intaking apparatus having air intaking function, so that it's possible to supplement air quickly for the gas curtain generating element 3 and the electrostatic eliminator. The filter element may be of a multilayer structure, and a specific material for each layer may be selected according to the situation of the impurity in the atmosphere where the device is located.

In at least one embodiment, the worktable 2 may be of a mesh structure so as to discharge the dust through meshes. Such a mesh structure can improve the effect of discharging the dust.

In at least one embodiment, the dedusting and destaticizing device may further include an air extractor 6 provided inside the support sidewall 12 for extracting the dust.

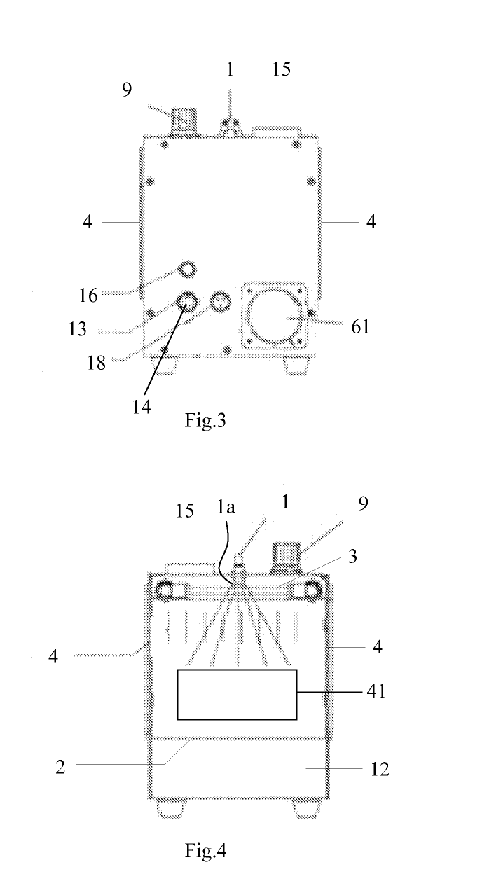

With the air extractor 6, the dust blown off the object to be cleaned may be discharged quickly from the worktable 2, so as to reduce the chance that the dust flies out from the worktable. As shown in FIG. 3, the dust exhaust hole 61 coupled to the air extractor 6 is provided at the back of the device and connected to a dust exhaust pipe, so that the dust is discharged to a region far away from the production line, and further, the mesh structure of the worktable can balance the force above the worktable when the air extractor is extracting air, so as to eliminate influence to the gas curtain around the worktable.

In at least one embodiment, the dedusting and destaticizing device may further include a air gauge 15 for displaying the pressure of the ionic wind sprayed by the electrostatic eliminator. For example, the air gauge may be provided at an upper surface of the rear box 11.

In one embodiment, the dedusting and destaticizing device may further include a gas-pressure regulating element 16 for regulating the pressure of the ionic wind sprayed by the electrostatic eliminator. For example, the gas-pressure regulating element 16 may be provided at the back of the dedusting and destaticizing device.

With the air gauge 15 and the gas-pressure regulating element 16, a user can inspect the numeric value of the air pressure at the ionic wind nozzle of the electrostatic eliminator conveniently, and regulate the air pressure as required, such that the air pressure is large enough to ensure the dedusting and destaticizing effect while no damage occurs to the object to be cleaned due to too large air pressure.

With the above-mentioned technical solutions, the destaticizing function, the dedusting function, the dust collection function and the like can be integrated so as to facilitate operations. Furthermore, after removing the dust and static electricity on the a component, no contamination is caused to the surrounding environment, and thus the overall dedusting quality for components on the production line is improved. In addition, embodiments of present disclosure are not limited to a specific device formation. For example, the whole device may be integrated into one box, or the function of the device may also be achieved by using the combination of individual discrete parts.

What are described above is related to the illustrative embodiments of the disclosure only and not limitative to the scope of the disclosure; the scopes of the disclosure are defined by the accompanying claims.

The present application claims the priority of the Chinese patent application No. 201410436252.9 filed on Aug. 29, 2014, the entirety of which is incorporated herein by reference as a part of the present application.

1. A dedusting and destaticizing device, comprising an electrostatic eliminator, a worktable and a gas curtain generating element, wherein
the electrostatic eliminator comprises an ionic wind nozzle and is configured for spraying an ionic wind toward the worktable so as to remove static electricity and dust from an object to be cleaned on the worktable;
the worktable is provided below the ionic wind nozzle of the electrostatic eliminator and configured for placement of the object to be cleaned and discharge of the dust; and
the gas curtain generating element is provided above the worktable and configured for spraying a gas toward the worktable, so as to form a gas curtain around the object to be cleaned.

2. The dedusting and destaticizing device according to claim 1, further comprising:
a support sidewall, provided below the worktable along an edge of the worktable and configured for supporting the worktable.

3. The dedusting and destaticizing device according to claim 2, further comprising:
a rear box, connected to the support sidewall and provided on a side of the worktable along an edge of the worktable.

4. The dedusting and destaticizing device according to claim 3, wherein the electrostatic eliminator further comprises an ionic blower and a conduit,
the ionic blower is provided within the rear box and configured for producing ions, mixing the ions with air and blowing the ions and the air into the conduit to form the ionic wind; and
an end of the conduit is connected to an upper surface of the ionic blower, and another end extends to an upper side of the worktable to form the ionic wind nozzle, and the conduit is configured for directing the ionic wind to the upper side of the worktable such that the ionic wind moves toward the worktable from top to bottom.

5. The dedusting and destaticizing device according to claim 4, further comprising:
a lateral cover, provided outside an edge of the worktable and with an opening to make it easier to place the object to be cleaned into the worktable and take the object to be cleaned out of the worktable; and
a top cover, provided above the gas curtain generating element and with a through hole, wherein the conduit passes through the through hole and sprays the ionic wind toward the worktable.

6. The dedusting and destaticizing device according to claim 1, further comprising:
a sensing element, configured for sensing whether the object to be cleaned exists on the worktable.

7. The dedusting and destaticizing device according to claim 6, further comprising:
a control element, coupled to the sensing element and configured for controlling the gas curtain generating element and the electrostatic eliminator to be turned on successively when the sensing element senses existence of the object to be cleaned on the worktable.

8. The dedusting and destaticizing device according to claim 7, wherein the control element comprises:
a first switch element, coupled to the sensing element and configured to control the gas curtain generating element to be turned on when the sensing element senses the existence of the object to be cleaned on the worktable; and
a second switch element, coupled to the first switch element and configured to control the electrostatic eliminator to be turned on when the gas curtain generating element is turned on.

9. The dedusting and destaticizing device according to claim 7, further comprising:
a time regulating element, configured for setting operation duration of the electrostatic eliminator,
wherein the control element turns off the gas curtain generating element and the electrostatic eliminator when a working time period of the electrostatic eliminator reaches the operation duration.

10. The dedusting and destaticizing device according to claim 1, further comprising:
an air inlet element, configured to supply air for the gas curtain generating element and/or the electrostatic eliminator; and
a filter element, provided at an entrance to the air inlet element and configured for filtering the air that enters the air inlet element.

11. The dedusting and destaticizing device according to claim 2, wherein the worktable is of a mesh structure.

12. The dedusting and destaticizing device according to claim 11, further comprising:
an air extractor provided within the support sidewall and configured for extracting the dust.

13. The dedusting and destaticizing device according to claim 1, further comprising:
an air gauge configured for displaying pressure of the ionic wind sprayed by the electrostatic eliminator.

14. The dedusting and destaticizing device according to claim 1, further comprising: a gas-pressure regulating element configured for regulating pressure of the ionic wind sprayed by the electrostatic eliminator.

15. The dedusting and destaticizing device according to claim 1, wherein the gas curtain generating element is provided above an edge of the worktable so as to generate a gas curtain at the edge of the worktable.

16. The dedusting and destaticizing device according to claim 3, wherein the gas curtain generating element comprises a first, second, third strip gas-jetting nozzles, each of the first and second strip gas-jetting nozzles is provided with an end coupled with the rear box and with another end coupled to the third strip gas-jetting nozzle.

17. The dedusting and destaticizing device according to claim 3, wherein the rear box is coupled with an air inlet element.

18. The dedusting and destaticizing device according to claim 5, wherein the lateral cover has three faces, and forms a three-dimensional space together with the top cover and a face of the rear box.

19. The dedusting and destaticizing device according to claim 1, wherein the electrostatic eliminator comprises an ionic blower provided below the worktable.

20. The dedusting and destaticizing device according to claim 19, wherein the gas curtain generating element comprises four gas-jetting nozzles.
